(19) United States
(12) Patent Application Publication
(10) Pub. No.: US 2010/0212059 A1
(43) Pub. Date: Aug. 26, 2010

(54) METHODS AND GARMENTS FOR DYE SUBLIMATION

(76) Inventor: Lee Peter Morrison, Cumming, GA (US)

Correspondence Address: MOORE & VAN ALLEN PLLC, P.O. BOX 13706, Research Triangle Park, NC, 27709, US

(21) Appl. No.: 12/712,139

(22) Filed: Feb. 24, 2010

Related U.S. Application Data
(60) Provisional application No. 61/154,938, filed on Feb. 24, 2009.

(51) Int. Cl. A41D 1/00; B44C 1/17; B32B 7/08; B32B 37/02

(52) U.S. Cl. 2/69; 156/235; 156/93

(57) ABSTRACT

Embodiments of the present invention provide an improved method for manufacturing a garment to be printed by dye sublimation printing. The method includes constructing a garment having first and second panels joined together along a perimeter edge by a seam, placing a piece of transfer paper having a pattern printed thereon with dye in contact with the garment such that the piece of transfer paper covers at least a portion of the first and second panels and extends over at least a portion of the seam, and applying heat to the piece of transfer paper and the garment to cause the dye on the transfer paper to sublimate such that the pattern from the transfer paper is visible on the portion of the first panel covered by the piece of transfer paper substantially to and along the portion of the at least one seam covered by the transfer paper, but is not visible on the second panel.

### FIELD

The invention generally relates to the field of dye sublimation, and more particularly, embodiments of the present invention relate to an improved method of manufacturing garments printed by dye sublimation printing.

### BACKGROUND

According to known methods of dying fabrics using dye sublimation, special heat-sensitive dyes are utilized to first print the desired designs, graphics, text, or other images (collectively referred to herein as a “pattern”) onto special transfer paper. The surface of the transfer paper onto which the patterns have been printed is then placed into direct content with a synthetic fabric, and the paper and the fabric are together placed into a heat press. The heat imparted by the heat press heats the transfer paper and fabric to approximately 400° F., causing the image on the paper to be transferred to the fabric. Specifically, the heat press subjects the paper to such a high temperature that the solid dye disposed on the transfer paper vaporizes into a gas directly from its solid state. The high temperature also serves to open the pores of the synthetic material and allow the dye vapor to immediately enter the material that directly contacts the transfer paper. As the temperature within the heat press cools, the fibers close and the gas reverts to a solid state, trapping the dye in the pores of the fabric fiber. Thus, the fabric contains a mirror image of the pattern previously disposed on the transfer paper.

In order to be successful, the dye sublimation process relies upon both the heat of the heat press and the contact between the transfer paper and the fabric. If there are gaps in the contact between the transfer paper and the fabric, the vaporized dye will be able to move about in the gap and will not be forced to enter the fabric in the same configuration that it had on the transfer paper. Because good contact between the transfer paper and the fabric is so critical to achieve the desired dye transfer and print quality using dye sublimation, manufacturers have been unable to use dye sublimation processes on preassembled garments to print any designs other than so-called “floating” designs, which designs appear on a portion of the garment which is able to be laid flat and at a distance from any seams. These “floating” designs have “white space” surrounding the design, which essentially comprises a perimeter of white or a light colored fabric surrounding the design. This is due to the fact that the standard construction and configuration of preassembled garments prevent uniform direct contact between the transfer paper and the garment, especially in those areas on and around the seams and hems. Thus, the limitations associated with using dye sublimation printing on a preassembled garment has prevented the use of such process to print patterns that extend to the hems or seams of the garment.

In order to obtain a garment having dye sublimation printing that extends to the hems or seams, raw fabric is subjected to the dye sublimation process according to the desired pattern prior to assembly of the garment, then cut and sewn to form the assembled garment. While this method of manufacturing dye sublimation garments works for relatively large orders, this method is not cost effective to produce individual units or orders of small quantity.

Thus, there remains a need for a method of utilizing dye sublimation printing on preassembled garments to print designs that extend to the seams and hems of the garments.

### BRIEF SUMMARY OF EMBODIMENTS OF THE INVENTION

Embodiments of the present invention solve the above-described problem and/or other problems by providing an improved method of manufacturing garments to be printed by dye sublimation printing after assembly. In particular, one embodiment of the present invention provides a method for manufacturing a garment to be printed by dye sublimation printing comprising: constructing a garment, the garment comprising first and second panels joined together along a perimeter edge of each of the first and second panels by at least one seam, wherein each of the first and second panels defines an interior surface and an exterior surface; providing a piece of transfer paper having a pattern printed thereon with dye; subsequent to the constructing step, placing the piece of transfer paper in contact with the garment such that the piece of transfer paper covers at least a portion of the first and second panels and extends over at least a portion of the at least one seam; and applying heat to at least a portion of the piece of transfer paper and at least a portion of the first and second panels and the at least one seam to cause the dye on the transfer paper to sublimate such that the pattern from the transfer paper is visible on the portion of the first panel covered by the piece of transfer paper substantially to and along the portion of the at least one seam covered by the transfer paper, but is not visible on the second panel. In one embodiment, the second panel comprises a non-printable panel.

According to another embodiment, the step of constructing the garment further comprises sewing together the first panel and the second panel along the at least one seam to define a seam allowance extending away from the interior surfaces of the first and second panels, and attaching at least a portion of the seam allowance to the interior surface of the first panel. In one embodiment, the seam allowance may be attached to the interior surface of the first panel by stitching. In another embodiment, the first and second panels is sewn together using an overlock stitch to form the at least one seam. In another embodiment, the piece of transfer paper is cut into substantially the same shape as the first panel. In another embodiment, the method includes the step of inserting a pad into the garment such that it contacts the interior surface of the printable panel. In one embodiment, the pad is a die-cut foam pad. According to one embodiment, prior to the step of placing the piece of transfer paper in contact with the garment, the first panel comprises white polyester fabric. In yet another embodiment, the second panel comprises black polyester fabric. In still another embodiment, the heat is applied to the printable panel and the transfer paper by a heat press.

According to another embodiment of the present invention, the method for manufacturing the garment to be printed by dye sublimation printing comprises: constructing a garment, the garment comprising first and second panels joined together along a perimeter edge of each of the first and second panels by at least one seam, wherein each of the first and second panels defines an interior surface and an exterior surface, the constructing step further comprising sewing together the first panel and the second panel along the at least one seam to define a seam allowance extending away from the interior surfaces of the first and second panels and attaching at least a portion of the seam allowance to the interior surface of the first panel, providing a piece of transfer paper having a pattern printed thereon with dye; subsequent to the constructing step, placing the piece of transfer paper in contact with the garment such that the piece of transfer paper covers at least a portion of the first and second panels and extends over at least a portion of the at least one seam; and applying heat to at least a portion of the piece of transfer paper and at least a portion of the first and second panels and the at least one seam to cause the dye on the transfer paper to sublimate to the garment.

In one embodiment, the pattern from the transfer paper is visible on the portion of the first panel covered by the piece of transfer paper substantially to and along the portion of the at least one seam covered by the transfer paper, but is not visible on the second panel. In one embodiment, the second panel is a non-printable panel. In one embodiment, the seam allowance may be attached to the interior surface of the first panel by stitching. In one embodiment, the first and second panels may be sewn together using an overlock stitch to form the at least one seam. In one embodiment, the piece of transfer paper is cut into substantially the same shape as the first panel. According to another embodiment, the method further includes the step of inserting a pad into the garment such that it contacts the interior surface of the printable panel. In yet another embodiment, prior to the step of placing the piece of transfer paper in contact with the garment, the first panel comprises white polyester fabric. In still another embodiment, the second panel comprises black polyester fabric.

In another embodiment of the present invention, the method for manufacturing a garment to be printed by dye sublimation printing comprises: constructing a garment, the garment comprising first and second panels joined together along a perimeter edge of each of the first and second panels by at least one seam, wherein each of the first and second panels defines an interior surface and an exterior surface; structuring the second panel so that the second panel comprises a non-printable panel; providing a piece of transfer paper having a pattern printed thereon with dye; subsequent to the constructing step, placing the piece of transfer paper in contact with the garment such that the piece of transfer paper covers at least a portion of the first and second panels and extends over at least a portion of the at least one seam; and applying heat to at least a portion of the piece of transfer paper and at least a portion of the first and second panels and the at least one seam to cause the dye on the transfer paper to sublimate such that the pattern from the transfer paper is visible on the portion of the first panel covered by the piece of transfer paper, but is not visible on the second panel.

In one embodiment, the step of structuring the second panel comprises providing a second panel formed of black polyester fabric. In another embodiment, the step of structuring the second panel comprises placing a cover over the second panel prior to the step of placing the piece of transfer paper in contact with the garment. According to one embodiment, the step of constructing the garment further comprises: sewing together the first panel and the second panel along the at least one seam to define a seam allowance extending away from the interior surfaces of the first and second panels; and attaching at least a portion of the seam allowance to the interior surface of the first panel. In one embodiment, the seam allowance is attached to the interior surface of the first panel by stitching. In one embodiment, the first and second panels are sewn together using an overlock stitch to form the at least one seam. In one embodiment, the piece of transfer paper is cut into substantially the same shape as the first panel. In another embodiment, the method includes inserting a pad into the garment such that the pad contacts the interior surface of the printable panel. In one embodiment, the pad is a die-cut foam pad. In one embodiment, prior to the step of placing the piece of transfer paper in contact with the garment, the first panel comprises white polyester fabric. In one embodiment, the heat is applied to the printable panel and the transfer paper by a heat press.

The present invention further provides a garment printed by dye sublimation printing. In one embodiment, the garment comprises: first and second panels, the first and second panels each defining an interior surface, an exterior surface, and a perimeter edge; at least one seam joining at least a portion of the perimeter edge of the first and second panels,; the at least one seam defining a seam allowance extending away from the interior surfaces of the first and second panels, at least a portion of the seam allowance being attached to the interior surface of the first panel; and a dye sublimation pattern visible on at least a portion of the first panel substantially to and along at least a portion of the at least one seam, but not visible on the second panel. In one embodiment, the least one seam comprises an overlock stitch to form the seam. In one embodiment, the second panel comprises a non-printable panel. In yet another embodiment, the second panel is structured to repel dye during dye sublimation printing. According to still another embodiment, the second panel comprises black polyester fabric.

In another embodiment of the present invention the garment printed by dye sublimation printing comprises: first and second panels, the first and second panels each defining an interior surface, an exterior surface, and a perimeter edge, the second panel comprising black polyester fabric; at least one seam joining at least a portion of the perimeter edge of the first and second panels; and a dye sublimation pattern visible on at least a portion of the first panel substantially to and along at least a portion of the at least one seam, but not visible on the second panel. In one embodiment, the at least one seam defines a seam allowance extending away from the interior surfaces of the first and second panels, at least a portion of the seam allowance being attached to the interior surface of the first panel. In another embodiment, the at least one seam comprises an overlock stitch to form the at least one seam.

Thus, the present invention provides a preassembled garment to be printed using dye sublimation printing in which the pattern extends to the hems or seams and a associated method of manufacturing and printing such garment. This method of manufacturing dye sublimation garments enables garments to be preassembly and, thereafter, printed in small and large quantities. As such, the method and garments of the present invention enable manufacturers of dye-sublimation-printed garments to derive the cost savings attainable by manufacturing (i.e., cutting, sewing and assembling) the garments in bulk, while at the same time having the flexibility to print using dye sublimation individual and smaller orders of garments, which heretofore was cost prohibitive.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIGS. 1A, 1B, and 1C are plan views illustrating garments in accordance with certain embodiments of the present invention;

FIGS. 2A, 2B, and 2C are diagrams illustrating the construction of the seams of the garments of the present invention, according to one embodiment of the present invention;

FIG. 3 is a flow chart detailing a method of manufacturing a garment printed using dye sublimation printing, according to one embodiment of the present invention;

FIG. 4 is a plan view illustrating how the dye sublimation transfer paper is applied to a garment in accordance with one embodiment of the present invention;

FIG. 5 is a cross-sectional view showing the heating of the transfer paper and garment using a heating press, in accordance with one embodiment of the present invention;

FIG. 6 is a cross-sectional view showing the heating of the transfer paper and garment using a heating press, in accordance with yet another embodiment of the present invention; and

FIG. 7 is a flow chart detailing a method of manufacturing a garment printed using dye sublimation printing, according to another embodiment of the present invention;

FIG. 8 is a flow chart detailing a method of manufacturing a garment printed using dye sublimation printing, according to another embodiment of the present invention; and

FIG. 9 is a flow chart detailing a method of manufacturing a garment printed using dye sublimation printing, according to yet another embodiment of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

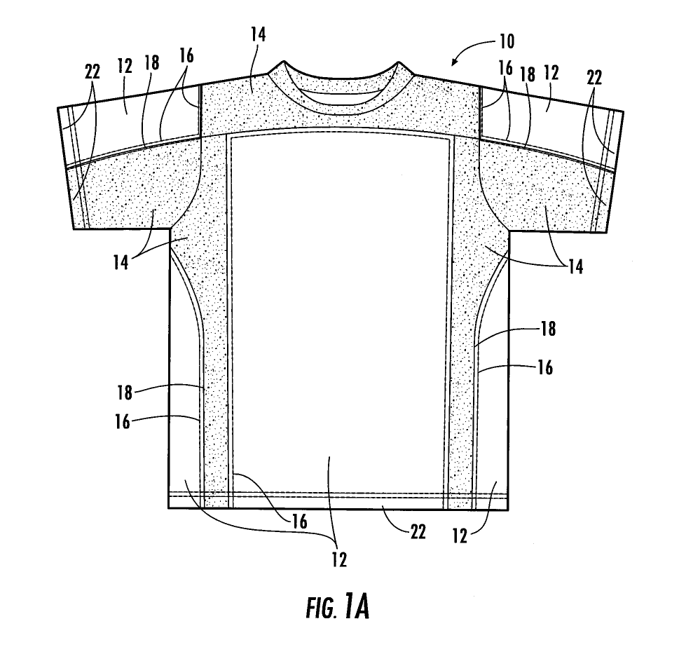

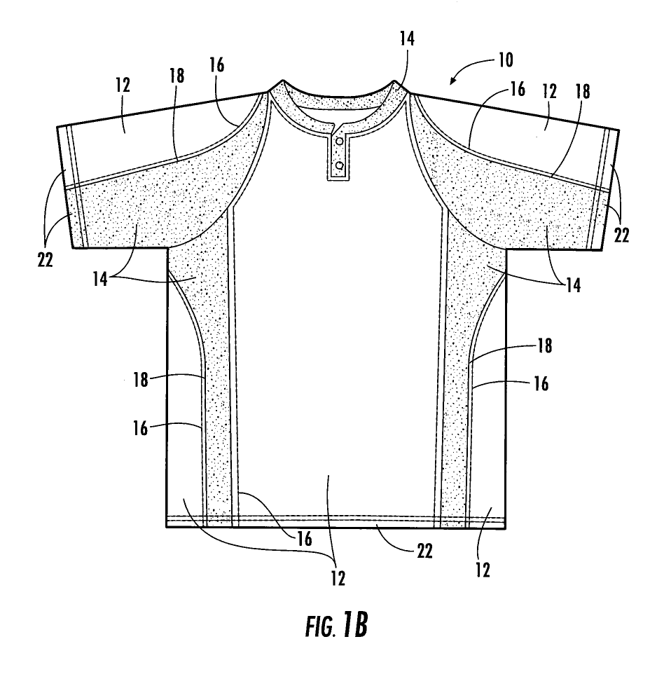

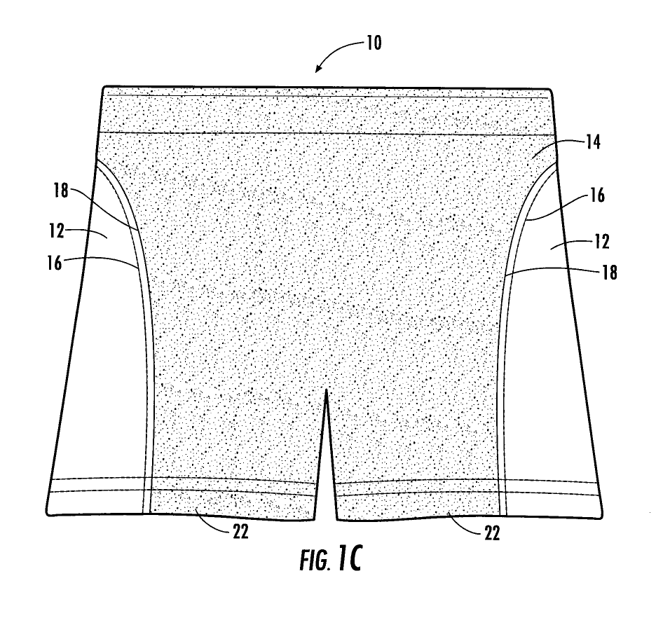

Referring to FIGS. 1A, 1B, and 1C, garments 10 in accordance with embodiments of the present invention are provided. The garment 10 may be any piece of wearable clothing, such as shorts, shirts, pants, jackets, headware, scarves, etc. In one embodiment, the garment 10 is part of a uniform, such as an athletic or sports uniform. The garment 10 comprises at least one first panel 12 and at least one second panel 14 joined together along a perimeter edge of each of the first panel 12 and second panel 14 by at least one seam 18. Each of the first panel 12 and second panel 14 defines an exterior and interior surface and perimeter edges. As used herein, a seam 18 comprises the joint between two adjacent panels or pieces of fabric in a garment 10. As illustrated in FIGS. 1A, 1B, and 1C, each garment 10 can comprise a plurality of first panels 12 and/or second panels 14.

The first panel 12 is made out of a synthetic material capable of being printed through dye sublimation printing, for example, polyester or a polymer or polymer-coated material. The first panel 12 may therefore be referred to herein as the “printable panel.” The printable panel 12 may be backed with additional material or fabric. In addition, while the printable panel 12 is illustrated in FIGS. 1A, 1B, and 1C as being constructed from a single piece of synthetic material, the printable panel could also comprise two or more pieces of material sewn together to form a single panel, provided the stitching is such that it would not negatively affect the result of the dye sublimation printing process, i.e., is likewise formed of a synthetic material and is constructed to ensure no gaps between the dye sublimation transfer paper and the garment. In addition, the printable panel 12 should be light in color so that any dye applied to the printable panel 12 during printing will be visible on the printable panel 12. In one embodiment, white 100% polyester fabric is used as the material for the printable panel 12.

As illustrated in FIGS. 1A, 1B, and 1C, the printable panel 12 is configured within the garment 10 such that the printable panel 12 is capable of being laid flat, which will be required during printing. For purposes of example and not limitation, in one embodiment, the printable panel 12 is positioned on the front, back and/or sides of the garment and/or on the upper and/or lower portions of the sleeves.

The second panel 14 is configured to either repel, in some instances due to a cover placed thereupon, or receive, yet not visibly show, any dye that reaches it during the dye sublimation printing process. The second panel 14 may therefore be referred to as the “non-printable panel.” The non-printable panel 14 may be made out of any material, including any synthetic or natural material. According to some embodiments, the non-printable panel 14 is made out of a dark 100% polyester fabric, such as black polyester. Other colors may be used provided such colors are dark enough that the dye from the dye sublimation printing process is not visible on the second panel 14. The non-printable panel 14 may be constructed out of a single piece of fabric or multiple pieces of fabric, according to different embodiments.

As shown in FIGS. 1A, 1B, and 1C and discussed above, the garment 10 may include a plurality of printable panels 12 and/or a plurality of non-printable panels 14. According to one embodiment, the non-printable panels 14 are configured within the garment 10 such that non-printable panels 14 are attached to all perimeter edges of the printable panels 12 other than those perimeter edges of the printable panels 12 that define the hems 22 of the garment 10. As used herein, a hem 22 comprises the joint created when terminating a first panel 12 or second panel 14 at the outer edge or perimeter of the garment 10. Thus, the non-printable panels 14 act as a non-printable border of the printable panels 12, ensuring that the designs printed on the garment 10 by dye sublimation printing are limited to the printable panels 12. In one embodiment, the non-printable panels 14 are configured within the garment 10 such that the non-printable panels 14 are located between the printable panels 12 and prevent the printable panels 12 from contacting one another. The non-printable panels 14 may also define the outer edge or perimeter of the garment, such as the hem 22, waistband, collar, or other edge. The specific configuration of the non-printable panels 14 may vary according to the configuration of printable panels 12 utilized. In the exemplary garment 10 of FIG. 1A, larger printable panels 12 are located on the front (and/or back) of the shirt and smaller printable panels 12 are located on the sides of the shirt and/or on top and/or bottom of the sleeves, while non-printable panels 14 are located around the collar, on the underside of the sleeves, and in between the front and side panels. FIGS. 1A, 1B, and 1C illustrate three exemplary embodiments of a garment 10 in accordance with the present invention, and one skilled in the art will understand that the teachings herein may be utilized with garments having other configuration.

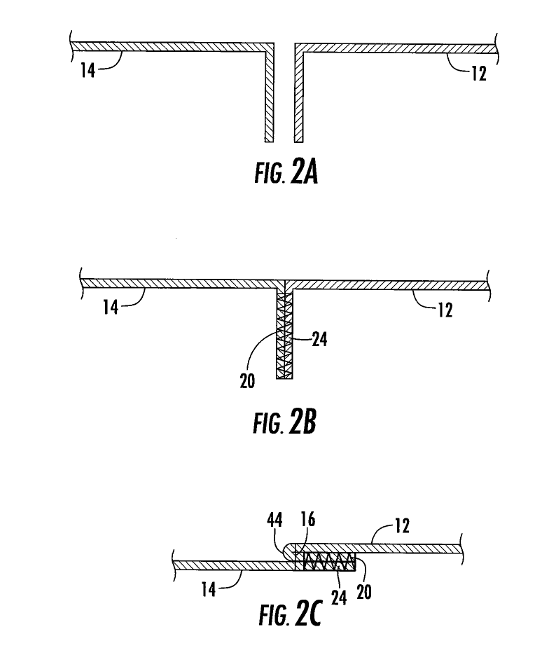

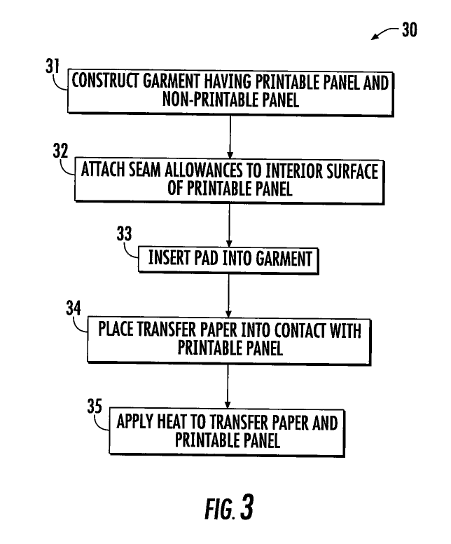

According to one embodiment, as illustrated in FIGS. 1A, 1B, and 1C, the printable panels 12 are sewn to the non-printable panels 14 along seams 18 that are constructed along the perimeter edges of the printable panels 12 and non-printable panels 14. In particular, in constructing the garment 10, the pieces of synthetic material/fabric that will form the printable panels 12 are sewn to the pieces of material/fabric that will form the non-printable panels 14. As illustrated in FIGS. 2A, 2B, and 2C, according to one embodiment, when the pieces of synthetic material/fabric that will form the printable panels 12 are sewn to the pieces of material/fabric that will form the non-printable panels 14, seams 18 are formed along the perimeter edges or boundaries between the printable panels 12 and the non-printable panels 14. In constructing the seams 18, a seam allowance 24 will typically extend away from the interior surfaces of the corresponding printable panel 12 and non-printable panel 14 along each of the seams, as illustrated in FIG. 2B. As illustrated in FIGS. 2A and 2B, the seam allowance 24 comprises the excess material of both the piece of synthetic material/fabric comprising the printable panel 12 and the piece of material/fabric comprising the non-printable panel 14 that is stitched together. In one embodiment, as illustrated in FIG. 2B, the excess material of both the piece of synthetic material/fabric comprising the printable panel 12 and the piece of material/fabric comprising the non-printable panel 14 are stitched together using an overlock stitch such that the excess material making up the seam allowance is also stitched together. In another embodiment, the excess material of both the piece of synthetic material/fabric comprising the printable panel 12 and the piece of material/fabric comprising the non-printable panel 14 can be sewn together at the base of the seam allowance only.

FIGS. 2A, 2B, and 2C contain diagrams illustrating the sequence of steps taken in constructing a seam 18 joining the printable panel 12 and the non-printable panel 14, according to one embodiment of the present invention. As shown in FIG. 2A, the piece of material/fabric comprising the printable panel 12 and the piece of material/fabric comprising the non-printable panel 14 are brought together such that the edges of each piece are aligned and some portion of the exterior surfaces of the pieces along the aligned edge are interfacing. The “exterior” surfaces of the pieces are the surfaces of the pieces that are intended to form the exterior of the garment 10. As shown in FIG. 2B, the two pieces of material/fabric are then stitched together, forming a seam 18 and a seam allowance 24. The seam allowance 24 extends away from the interior of the corresponding printable panel 12 and non-printable panel 14 along each of the seams. Even though FIG. 2B shows the pieces of material/fabric forming the seam 18 being stitched together using an overlock stitch 20 that also stitches together the material in the seam allowance 24, it should be understood that the pieces could be stitched together using a straight stitch or other stitch that allows the two pieces of excess material in the seam allowance to remain unattached from one another. In another embodiment, a stitch may not be used at all, and the pieces of material may be attached using glue, fabric tape, ultrasonic welding, or other adhesives or fastening methods for securing pieces of fabric together.

According to one embodiment of the present invention, as illustrated in FIG. 2C, after the piece of material/fabric for the printable panel 12 and the piece of material/fabric for the non-printable panel 14 are stitched together to define a seam 18 joining the perimeter edge of the printable panel 12 and the perimeter edge of the non-printable panel 14, and creating the seam allowance 24, at least a portion of the seam allowance 24 is attached to the interior surface of the printable panel 12. According to one embodiment, as shown in FIG. 2C, the seam allowance 24 is turned under the printable panel 12 and at least a portion of the seam allowance 24 is attached to the interior surface of the printable panel 12 by single needle stitching 16, which is illustrated in FIGS. 1A, 1B and 1C. The seam allowance 24 may be attached to the underside of the printable panel 12 by a single or multiple stitches, or by glue, fabric tape, ultrasonic welding, or other adhesives or fastening methods for securing pieces of fabric together. If stitches are used, the material and the color of the stitch should be selected with care, as the stitches will appear on the outer surface of the printable panel 12 and be subjected to the dye sublimation printing process. Thus, in one embodiment, white synthetic thread is used to stitch at least a portion of the seam allowance 24 to the interior surface of the printable panel 12 so that the thread may be printed along with the rest of the printable panel 12 during the dye sublimation printing process, causing the stitching to be less noticeable on the printed garment 10. Alternatively, a black thread (or other colored thread) may be used to provide a contrast stitch against the printed printable panel 12.

Referring again to FIGS. 1A, 1B, and 1C, the single needle stitching 16 used to stitch down at least a portion of the seam allowances 24 is shown near the perimeter of the printable panels 12. Using an overlock stitch 20 on the seam allowance 24, whether as a means for stitching together the two pieces of material/fabric and generating the seam 18 or as a separate step in addition to stitching together the two pieces of material, is advantageous as it binds the two pieces of material/fabric in the seam allowance 24 together and allows these pieces to be more securely attached to the interior surface of the printable panel 12. By folding the seam allowance 24 underneath the corresponding printable panel 12, the outer edge of the exterior surface of the printable panel creates a slight lip or raised portion 44 that extends slightly over the edge of the non-printable panel 14, as illustrated in FIG. 2C. As will be discussed in greater detail below, securely attaching the seam allowance 24 to the interior surface of the printable panel 12 advantageously allows for the printable panel 12 to be printed substantially to and along at least a portion of the seam 18, after the garment 10 is assembled using dye sublimation printing. In one embodiment, the present invention allows substantially the entire printable panel 12 to be printed after the garment 10 is assembled using dye sublimation printing.

In one embodiment, just as at least a portion of each seam allowance 24 is securely attached to the interior surface of a printable panel 12, in the event any edge of a printable panel 12 defines a hem 22 of the garment 10, the synthetic material used to make the printable panel 12 that is turned under to form the hem of the garment is securely attached to the interior surface of the printable panel 12. Thus, at least a portion of any material/fabric that is capable of falling underneath a printable panel 12 of the garment 10 following construction, whether a seam allowance 24 or a hem 22, should be securely attached to the interior surface of the printable panel 12 as discussed above.

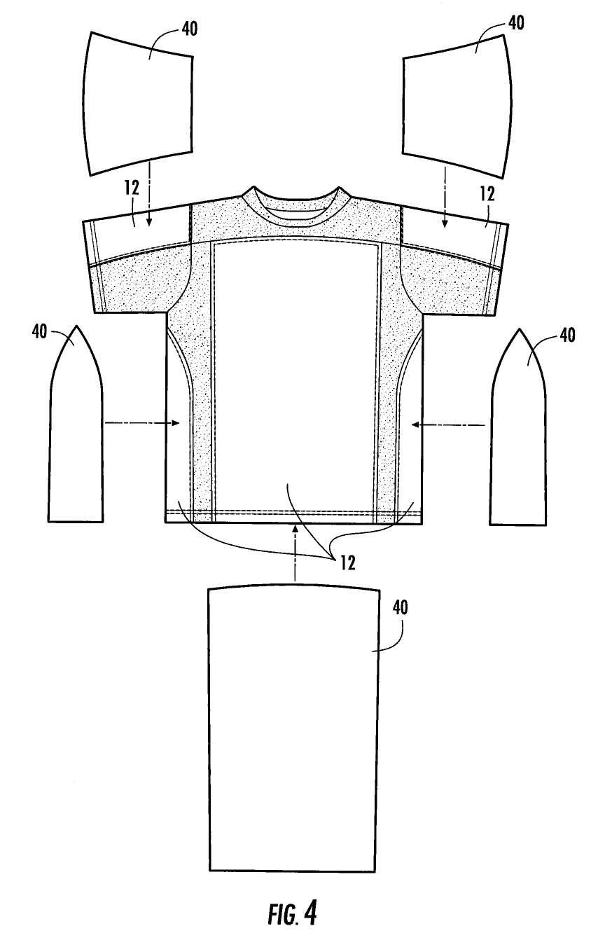

Referring now to FIG. 3, a flow chart detailing a method of manufacturing a garment 10 printed using dye sublimation printing, according to one embodiment of the present invention is provided. As represented by block 31, as a first step, the garment 10 is constructed having a printable panel 12 and a non-printable panel 14 joined together along a perimeter edge of the printable panel 12 and the non-printable panel 14 by a seam 18. In some embodiments, the garment has a plurality of printable panels 12 and/or non-printable panels 14 configured such that the non-printable panels 14 are disposed along all edges of the printable panels 12 other than those edges of the printable panels 12 that define the hems 22 of the garment 10. According to block 32, any seam allowances 24 extending away from the interior surfaces of the corresponding printable panels 12 and non-printable panels 14 of the garment 10 along the seams 18 attaching the printable panels 12 to the non-printable panels 14 are stitched down to the interior surface of the printable panels 12 and any hems 22 along the outer edges of the printable panels 12 are stitched down to the interior of the printable panels 12 as well.

As represented by block 33, a special pad 26 having the same shape as a printable panel 12 is inserted into the garment 10 under the printable panel 12 that has the matching shape such that the pad contacts all or substantially all of the portion of the interior surface of the printable panel 12 that corresponds to the portion to be printed by dye sublimation. In particular, the printable panel 12 is laid flat directly on top of the pad 26. In some embodiments, the pad 26 comprises a die-cut piece of foam covered with a heat-resistant material. The pad 26 ensures that no scorching will occur as a result of the heat applied by the heat press 28 during the dye sublimation printing process and further serves to eliminate transfer paper lines. Because the surface of the pad 26 is not rigid and will yield when pressure is applied, the pad 26 promotes full contact between the printable panel 12 and the printed transfer paper when the heat press 28 is utilized, as discussed further below.

Next, as represented by block 34, a piece of printed dye sublimation transfer paper 34 is cut to match the shape of a printable panel 12 and is placed in contact with the printable panel 12. Referring now to FIG. 4, an illustration demonstrating how the dye sublimation transfer paper 40 is applied to the garment 10 is provided. In particular, FIG. 4 shows a plurality of pieces of transfer paper 40 cut to match the shape of the printable panels 12 of the garment 10. However, according to one embodiment of the present invention, only one piece of transfer paper 40 will be placed into contact with its matching printable panel 12 at a time for the purposes of dye sublimation printing. While the piece of transfer paper 40 is cut to match the shape of the printable panel 12, it is slightly greater in size than the printable panel 12 to ensure that it will cover the entire printable panel 12. For example, this oversizing may be between approximately 0.025 cm to approximately 0.2 cm beyond the perimeter edge of the non-printable panel 14. With regard to the transfer paper 40, a mirror image of the pattern desired on the printable panel 12 is printed onto the transfer paper. The transfer paper 40 may be cut to the correct shape prior to being printed or after being printed. The surface of the transfer paper 40 that contains the dye from the printer is then placed into direct contact with the exterior surface of the corresponding printable panel 12 such that the piece of transfer paper 40 contacts the portion of the exterior surface of the printable panel 12 to be printed by dye sublimation, as well as at least a portion of the neighboring non-printable panels 14 and at least a portion of the seams joining the printable panel 12 to the neighboring non-printable panels 14. In one embodiment, however, the piece of transfer paper 40 may be placed in contact with all or substantially all of the entire exterior surface of the printable panel 12. Following placement of the piece of transfer paper 40, the pad 26 is in contact with the interior surface of the printable panel 12 and the printed transfer paper is in contact with the exterior surface of the printable panel 12.

Referring again to FIG. 3, as represented by block 35, the assembly of pad 26, garment 10, and transfer paper 40 is placed in a heat press and the heat press applies heat and pressure to cause the dye from the transfer paper to sublimate and enter the printable panel 12 in the intended pattern. Referring to FIG. 5, the configuration of the pad 26, garment 10, and transfer paper 40 during heating is illustrated. In particular, a heating element 28 contacts the unprinted side of the transfer paper 40. The printed side of the transfer paper 40 contacts the garment 10, specifically contacting a portion of the printable panel 12 as well as at least a portion of the non-printable panels 14 and the seams 18 joining the printable panels to the non-printable panels. The pad 26 is inserted into the garment 10 such that it lies directly under the printable panel 12. The entire assembly is laid upon a support surface 30. According to one embodiment, both the support surface 30 and the heating element 28 are components of the heat press.

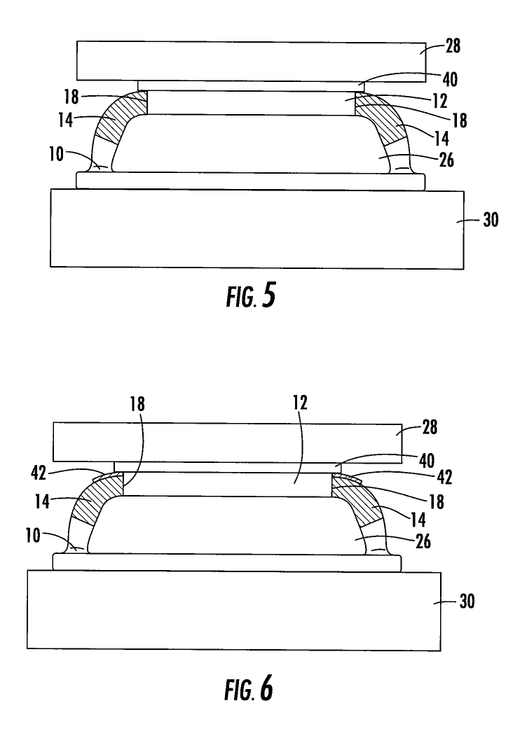

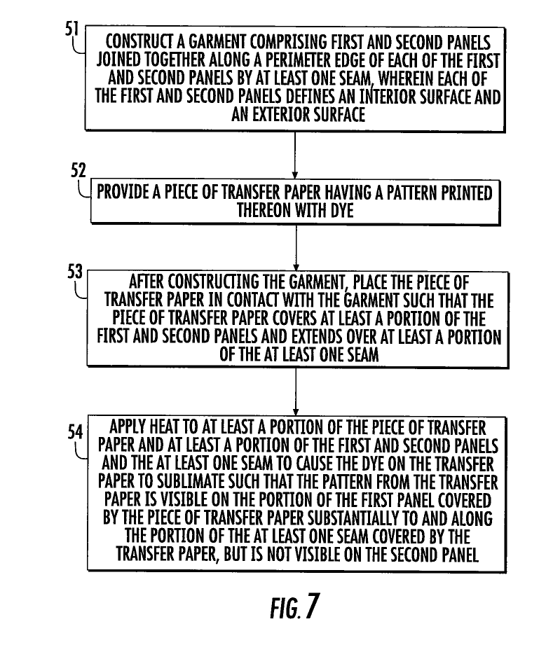

Referring now to FIG. 6, the same assembly illustrated in FIG. 5 is shown with the addition of covers 42 placed upon the non-printable panels 14. In one embodiment, the covers 42 comprise dye-resistant tape. As shown in FIG. 5, rather than the printed side of the transfer paper 40 contacting a portion of the printable panel 12 and at least a portion of the non-printable panels 12 and the seams 18 joining the printable panels to the non-printable panels, the transfer paper 40 contacts a portion of the printable panel 12, a portion of the covers 42 covering the non-printable panels 14, and at least a portion of the seams 18 joining the printable panel 12 to the non-printable panels 14. Thus, the covers 42, rather than the non-printable panels 14, will receive or repel the dye during the dye sublimation printing process.

Because of the unique configuration of the garment 10 as described herein, in particular the configuration of the printable panels 12 and the non-printable panels 14 and the attachment of all at least a portion of the seam allowances 24 extending from the seams 18 joining the printable panels 12 to the non-printable panels 14 to the interior surface of the printable panels 12, and because both the piece of transfer paper 40 and the pad 26 are in contact with the corresponding exterior surface and interior surface, respectively, of the printable panel 12, the pattern is able to successfully be printed on the exterior surface of the printable panel 12 substantially to and along at least a portion of the seam 18. In particular, stitching down at least a portion of the seam allowance 24 to the interior surface of the printable panel 12 causes the lip or raised portion 44 of the printable panel 12 to be raised above the adjacent corresponding non-printable panel 14 to which it is attached when the garment 10 is laid out so that the printable panel 12 is laid flat as it enters the heat press. This advantageously ensures that the contact between the piece of transfer paper 40 and the printable panel 12 is not disrupted because of the seam or because the non-printable panel 14 is raised above the printable panel 12. Even though the lip or raised portion 44 may lay higher than the printable panel 12 when the garment 10 is laid flat for printing, using the pad 26 directly underneath the printable panel 12 ensures the transfer paper 40 will not lose contact with printable panel 12 even around the raised portion 44, as the pad 26 will yield around the raised portion 44 under the pressure applied by the heat press. Thus, the method of stitching the seam allowances 24 as disclosed herein, combined with the use of a pad 26 during application of the heat press, ensure that there is good contact between the printable panel 12 and the transfer paper 40 during dye sublimation printing. It is also these aspects of the present invention that allow the printable panel 12 to be printed by dye sublimation printing substantially to and along at least a portion of the seam 18 (or, in other embodiments, the entire seam) defined at the edges of the printable panel 12. This is a significant advance over the floating designs, which are currently the only designs that can be successfully printed on preassembled garments using dye sublimation printing.

During printing, the non-printable panels 14 serve to capture or repel any dye from the piece of transfer paper 40 that does not enter the printable panel 12. For example, the non-printable panels 14 may be constructed of a dark synthetic material like black polyester (or another dark color) and, thus, will capture any excess dye without such dye being visible on the non-printable panel 14 of the garment 10. The color of the non-printable panel 14 does not need to be black in order to not visibly show the dye; in fact, according to some embodiments, the color of the non-printable panel 14 is chosen according to what is known as the “HSV” color space, such that the non-printable panel 14 has a color of similar hue, but substantially lower saturation, as the color of the dye that enters the non-printable panel 14, in order that the dye will not be visible upon the non-printable panel 14. In other embodiments, the non-printable panels 14 may be constructed of a material that repels the dye vapor generated during the dye sublimation printing process. According to still other embodiments, the non-printable panels 14 may be constructed of any material and the edges of the non-printable panels 14 along the seam with the printable panel 12 may be covered with a dye-resistant tape or other cover that repels or captures escaped dye during the dye sublimation printing process. Regardless of which method is utilized, the non-printable panels 14 provide a border (except along those perimeter edges of the printable panels 14 that are hems 22) to each printable panel 12 that ensures that the dye and pattern transferred from the piece of transfer paper 40 is only visible in the printable panel 12 where it was intended to be visible.

The present invention advantageously enables manufacturers to manufacture so-called “blank” garments in bulk prior to printing without having to sacrifice the desirable “all-over” print look. While manufacturers were previously limited to pre-printing and then assembling garments or, alternatively, using floating designs in the middle of white space or other light-colored spaces if they chose to construct their garments prior to dye sublimation printing, using the methods of the present invention, manufacturers can now fill different custom orders using the blank garments and the garments will have print on them all the way to the edges of the printable panels, if so desired, including the hems and seams, of the printable panels. The present invention therefore provides a cost-effective method for manufacturers to produce dye sublimation printed garments, especially in the case of individual or relatively smaller orders.

Referring now to FIG. 7, a flow chart detailing a method of manufacturing a garment printed using dye sublimation printing according to another embodiment of the present invention is provided. As represented by block 51, the first step the first step involves constructing a garment 10 comprising first and second panels 12, 14 joined together along a perimeter edge of each of the first and second panels 12, 14 by at least one seam 18, wherein each of the first and second panels 12, 14 defines an interior surface and an exterior surface. As represented by block 52, the next step involves providing a piece of transfer paper 40 having a pattern printed thereon with dye. Next, according to block 53, after the garment 10 is constructed, the piece of transfer paper 40 is placed in contact with the garment 10 such that the piece of transfer paper 40 covers at least a portion of the first and second panels 12, 14 and extends over at least a portion of the at least one seam 18. Finally, as represented by block 54, heat is applied to at least a portion of the piece of transfer paper 40 and at least a portion of the first and second panels 12, 14 and the at least one seam 18 to cause the dye on the transfer paper to sublimate such that the pattern from the transfer paper 40 is visible on the portion of the first panel 12 covered by the piece of transfer paper 40 substantially to and along the portion of the at least one seam 18 covered by the transfer paper 40, but is not visible on the second panel 14.

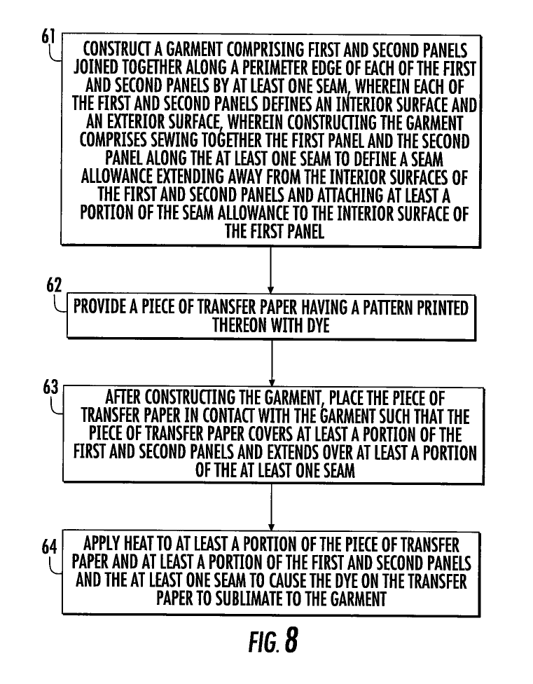

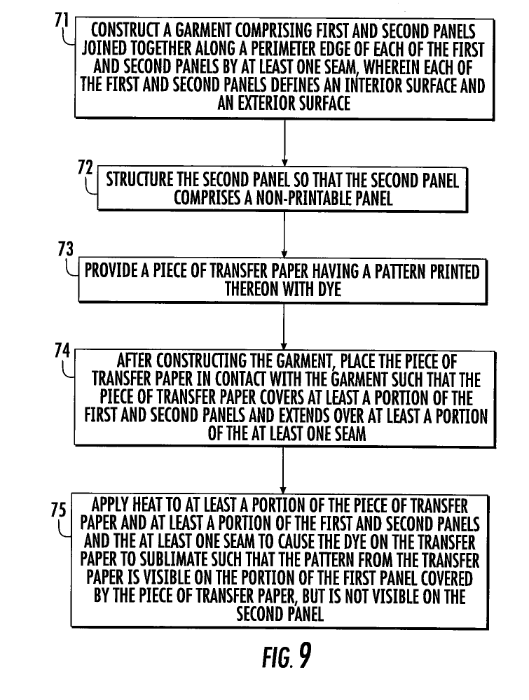

Referring now to FIG. 8, a flow chart detailing a method of manufacturing a garment printed using dye sublimation printing according to another embodiment of the present invention is provided. As represented by block 61, the first step involves constructing a garment 10 comprising first and second panels 12, 14 joined together along a perimeter edge of each of the first and second panels 12, 14 by at least one seam 18, wherein each of the first and second panels 12, 14 defines an interior surface and an exterior surface and wherein constructing the garment 10 comprises sewing together the first panel 12 and the second panel 14 along the at least one seam 18 to define a seam allowance 24 extending away from the interior surfaces of the first and second panels 12, 14 and attaching at least a portion of the seam allowance 24 to the interior surface of the first panel 12. Next, as represented by block 62, a piece of transfer paper 40 having a pattern printed thereon with dye is provided. As represented by block 63, after constructing the garment 10, the piece of transfer paper 40 is placed in contact with the garment 10 such that the piece of transfer paper 40 covers at least a portion of the first and second panels 12, 14 and extends over at least a portion of the at least one seam 18. Finally, as represented by block 64, heat is applied to at least a portion of the piece of transfer paper 40 and at least a portion of the first and second panels 12, 14 and the at least one seam 18 to cause the dye on the transfer paper 40 to sublimate to the garment 10.

Referring now to FIG. 9 is a flow chart detailing a method of manufacturing a garment printed using dye sublimation printing according to yet another embodiment of the present invention is provided. As represented by block 71, the first step the first step involves constructing a garment 10 comprising first and second panels 12, 14 joined together along a perimeter edge of each of the first and second panels 12, 14 by at least one seam 18, wherein each of the first and second panels 12, 14 defines an interior surface and an exterior surface. As represented by block 72, the second panel 14 is structured so that the second panel 14 comprises a non-printable panel. As represented by block 73, the next step involves providing a piece of transfer paper 40 having a pattern printed thereon with dye. Next, according to block 74, after the garment 10 is constructed, the piece of transfer paper 40 is placed in contact with the garment 10 such that the piece of transfer paper 40 covers at least a portion of the first and second panels 12, 14 and extends over at least a portion of the at least one seam 18. Finally, as represented by block 75, heat is applied to at least a portion of the piece of transfer paper 40 and at least a portion of the first and second panels 12, 14 and the at least one seam 18 to cause the dye on the transfer paper to sublimate such that the pattern from the transfer paper 40 is visible on the portion of the first panel 12 covered by the piece of transfer paper 40 substantially to and along the portion of the at least one seam 18 covered by the transfer paper 40, but is not visible on the second panel 14.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A method for manufacturing a garment to be printed by dye sublimation printing, the method comprising:
constructing the garment, the garment comprising first and second panels joined together along a perimeter edge of each of the first and second panels by at least one seam, wherein each of the first and second panels defines an interior surface and an exterior surface;
providing a piece of transfer paper having a pattern printed thereon with dye;
subsequent to said constructing step, placing the piece of transfer paper in contact with the garment such that the piece of transfer paper covers at least a portion of the first and second panels and extends over at least a portion of the at least one seam; and
applying heat to at least a portion of the piece of transfer paper and at least a portion of the first and second panels and the at least one seam to cause the dye on the transfer paper to sublimate such that the pattern from the transfer paper is visible on the portion of the first panel covered by the piece of transfer paper substantially to and along the portion of the at least one seam covered by the transfer paper, but is not visible on the second panel.

2. The method of claim 1 wherein the second panel comprises a non-printable panel.

3. The method of claim 1, wherein said step of constructing the garment further comprises:
sewing together the first panel and the second panel along the at least one seam to define a seam allowance extending away from the interior surfaces of the first and second panels; and
attaching at least a portion of the seam allowance to the interior surface of the first panel.

4. The method of claim 3, wherein the at least a portion of the seam allowance is attached to the interior surface of the first panel by stitching.

5. The method of claim 3, wherein the first and second panels are sewn together using an overlock stitch to form the at least one seam.

6. The method of claim 1, wherein the piece of transfer paper is cut into substantially the same shape as the first panel.

7. The method of claim 1, further comprising the step of inserting a pad into the garment such that it contacts the interior surface of the printable panel.

8. The method of claim 6, wherein the pad is a die-cut foam pad.

9. The method of claim 1, wherein, prior to said placing step, the first panel comprises white polyester fabric.

10. The method of claim 1, wherein the second panel comprises black polyester fabric.

11. The method of claim 1, wherein the heat is applied to the printable panel and the transfer paper by a heat press.

12. A method for manufacturing a garment to be printed by dye sublimation printing, the method comprising:
constructing the garment, the garment comprising first and second panels joined together along a perimeter edge of each of the first and second panels by at least one seam, wherein each of the first and second panels defines an interior surface and an exterior surface, said constructing step further comprising sewing together the first panel and the second panel along the at least one seam to define a seam allowance extending away from the interior surfaces of the first and second panels and attaching at least a portion of the seam allowance to the interior surface of the first panel;
providing a piece of transfer paper having a pattern printed thereon with dye;
subsequent to said constructing step, placing the piece of transfer paper in contact with the garment such that the piece of transfer paper covers at least a portion of the first and second panels and extends over at least a portion of the at least one seam; and
applying heat to at least a portion of the piece of transfer paper and at least a portion of the first and second panels and the at least one seam to cause the dye on the transfer paper to sublimate to the garment.

13. The method of claim 12 wherein the pattern from the transfer paper is visible on the portion of the first panel covered by the piece of transfer paper substantially to and along the portion of the at least one seam covered by the transfer paper, but is not visible on the second panel.

14. The method of claim 13 wherein the second panel comprises a non-printable panel.

15. The method of claim 12, wherein the at least a portion of the seam allowance is attached to the interior surface of the first panel by stitching.

16. The method of claim 12, wherein the first and second panels are sewn together using an overlock stitch to form the at least one seam.

17. The method of claim 12, wherein the piece of transfer paper is cut into substantially the same shape as the first panel.

18. The method of claim 12, further comprising the step of inserting a pad into the garment such that it contacts the interior surface of the printable panel.

19. The method of claim 12, wherein, prior to said placing step, the first panel comprises white polyester fabric.

20. The method of claim 12, wherein the second panel comprises black polyester fabric.

21. A method for manufacturing a garment to be printed by dye sublimation printing, the method comprising:
constructing the garment, the garment comprising first and second panels joined together along a perimeter edge of each of the first and second panels by at least one seam, wherein each of the first and second panels defines an interior surface and an exterior surface;
structuring the second panel so that the second panel comprises a non-printable panel;
providing a piece of transfer paper having a pattern printed thereon with dye;
subsequent to said constructing step, placing the piece of transfer paper in contact with the garment such that the piece of transfer paper covers at least a portion of the first and second panels and extends over at least a portion of the at least one seam; and
applying heat to at least a portion of the piece of transfer paper and at least a portion of the first and second panels and the at least one seam to cause the dye on the transfer paper to sublimate such that the pattern from the transfer paper is visible on the portion of the first panel covered by the piece of transfer paper, but is not visible on the second panel.

22. The method of claim 21 wherein said step of structuring the second panel comprises providing a second panel formed of black polyester fabric.

23. The method of claim 22 wherein said step of structuring the second panel comprises placing a cover over the second panel prior to said step of placing the piece of transfer paper in contact with the garment.

24. The method of claim 21, wherein said step of constructing the garment further comprises:
sewing together the first panel and the second panel along the at least one seam to define a seam allowance extending away from the interior surfaces of the first and second panels; and
attaching at least a portion of the seam allowance to the interior surface of the first panel.

25. The method of claim 24, wherein the at least a portion of the seam allowance is attached to the interior surface of the first panel by stitching.

26. The method of claim 24, wherein the first and second panels are sewn together using an overlock stitch to form the at least one seam.

27. The method of claim 21, wherein the piece of transfer paper is cut into substantially the same shape as the first panel.

28. The method of claim 21, further comprising the step of inserting a pad into the garment such that it contacts the interior surface of the printable panel.

29. The method of claim 28, wherein the pad is a die-cut foam pad.

30. The method of claim 21, wherein, prior to said placing step, the first panel comprises white polyester fabric.

31. The method of claim 1, wherein the heat is applied to the printable panel and the transfer paper by a heat press.

32. A garment printed by dye sublimation printing, the garment comprising:
first and second panels, said first and second panels each defining an interior surface, an exterior surface, and a perimeter edge;
at least one seam joining at least a portion of the perimeter edge of said first and second panels, said at least one seam defining a seam allowance extending away from the interior surfaces of said first and second panels, at least a portion of said seam allowance being attached to the interior surface of said first panel; and
a dye sublimation pattern visible on at least a portion of said first panel substantially to and along at least a portion of said at least one seam, but not visible on said second panel.

33. The garment of claim 32, wherein said at least one seam comprises an overlock stitch to form said at least one seam.

34. The garment of claim 32, wherein said second panel comprises a non-printable panel.

35. The garment of claim 34, wherein said second panel is structured to repel dye during dye sublimation printing.

36. The garment of claim 324, wherein said second panel comprises black polyester fabric.

37. A garment printed by dye sublimation printing, the garment comprising:
first and second panels, said first and second panels each defining an interior surface, an exterior surface, and a perimeter edge, the second panel comprising black polyester fabric;
at least one seam joining at least a portion of the perimeter edge of said first and second panels; and
a dye sublimation pattern visible on at least a portion of said first panel substantially to and along at least a portion of said at least one seam, but not visible on said second panel.

38. The garment of claim 37 wherein said at least one seam defines a seam allowance extending away from the interior surfaces of said first and second panels, at least a portion of said seam allowance being attached to the interior surface of said first panel.

39. The garment of claim 37, wherein said at least one seam comprises an overlock stitch to form said at least one seam.
